(19) United States
(12) Patent Application Publication
(10) Pub. No.: US 2011/0157092 A1
(43) Pub. Date: Jun. 30, 2011

(54) ELECTRONIC DEVICE WITH TOUCH INPUT FUNCTION

(75) Inventor: SONG-LING YANG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/912,755

(22) Filed: Oct. 27, 2010

(30) Foreign Application Priority Data
Dec. 30, 2009 (CN) 200910312679.7

(51) Int. Cl. G06F 3/042

(52) U.S. Cl. 345/175

(57) ABSTRACT

A method for controlling an electronic device with touch input function includes controlling at least two light emitting devices to emit monochromatic light to have a total internal reflection in a sheet of glass. Detecting two intersected light paths obstructed by at least two light detecting devices; sending information of the two intersected obstructed light paths to a central processing unit (CPU); and the CPU determining a position of a touch operation according to information of the two intersected obstructed light paths. An electronic device with touch input function is also provided.

### BACKGROUND

1. Technical Field

The present disclosure relates to electronic devices with touch input functions which can detect touch operations and, particularly, to an electronic device and a control method using a principle of total internal reflection to determine a position of the touch operation.

2. Description of Related Art

Electronic devices with touch input function are using the principle of total internal reflection to determine position of touch input points. When a touch screen of the electronic device is touched, the total internal reflection is destroyed, and a camera under the touch screen captures the touch point where the total reflection is destroyed, thereby the position of the touch point is determined.

However, the camera needs to monitor the touch screen in real time, furthermore, the location of the touch point needs to be determined, and the determined process is relatively complex.

Therefore, it is necessary to provide an electronic device and a control method using principle of total internal reflection to determine touch point in a simpler way.

### BRIEF DESCRIPTION OF THE DRAWINGS

Many aspects of the present disclosure should be better understood with reference to the following drawings. The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an exploded, schematic view showing an electronic device with a touch input function.

FIG. 2 is a block diagram of the electronic device of FIG. 1.

FIG. 3 is a schematic diagram showing an internal configuration of the electronic device of FIG. 2 in accordance with a first exemplary embodiment.

FIG. 4 is a schematic diagram showing a principle of total internal reflection without a touch input.

FIG. 5 is a schematic diagram showing the principle of total internal reflection with a touch input.

FIG. 6 is a flowchart of implementing a method of controlling the electronic device of FIG. 1, according to one exemplary embodiment.

### DETAILED DESCRIPTION

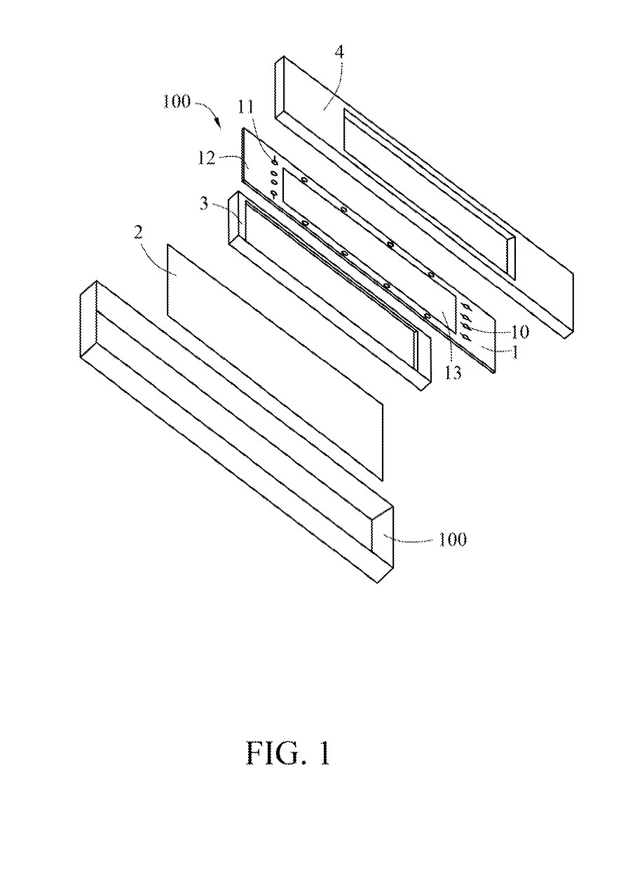

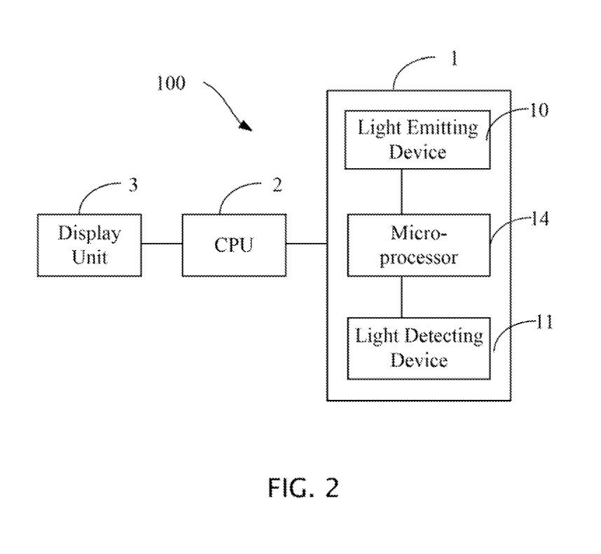

Referring to FIGS. 1-2, the electronic device 100 includes a touch input device 1, a central processing unit (CPU) 2, a display unit 3, a frame 4, and a back cover 5. The CPU 2 is electronically connected to the touch input device 1 and the display unit 3. The touch screen 1, the CPU 2 and display unit 3 are installed in the space formed between the frame 4 and the back cover 5.

The display unit 3 may be a flat panel display defining an information display area. The touch input device 1 includes a circuit board 12 defining an opening area, which has a same size and shape as the information display area. The touch input device 1 further includes at least one light emitting device 10 and at least one light detecting device 11, a sheet of glass 13, which is mounted with a surface coating, and a micro-processor 14. The micro-processor 14 is electronically connected with the light emitting device 10 and the light detecting devices 11. The sheet of glass 13 is positioned on the circuit board 12. The light emitting devices 10 and the light detecting devices 11 are disposed around the edges of the sheet of glass 13 on the circuit board 12.

In an exemplary embodiment, the light emitting devices 10 are light emitting diodes that emit monochromatic light, the light detecting devices 11 can be photosensitive elements, such as high-sensitivity photodiode, which changes optical signals into electrical signals. The light detecting devices 11 detect the monochromatic light emitted by the light emitting devices 10. Each of the light emitting devices 10 corresponds to one light detecting device 11. That is, the monochromatic light emitted from one of the light emitting devices 10 is detected by one light detecting device 11, contrarily; each of the light detecting devices 11 only detects the monochromatic light emitted from one light emitting device 10. The monochromatic light transmitted between the light emitting device 10 and the corresponding light detecting devices 11 forms a light path.

When one touch operation is implemented on the electronic device 100, at least two intersected light paths are obstructed. The micro-processor 14 sends the information of the obstructed light paths to the CPU 2. The information of the obstructed light paths includes positions of the light emitting device 10 and the corresponding light detecting device 11. The CPU 2 determines a position of the touch operation according to the information of the two intersected obstructed light paths.

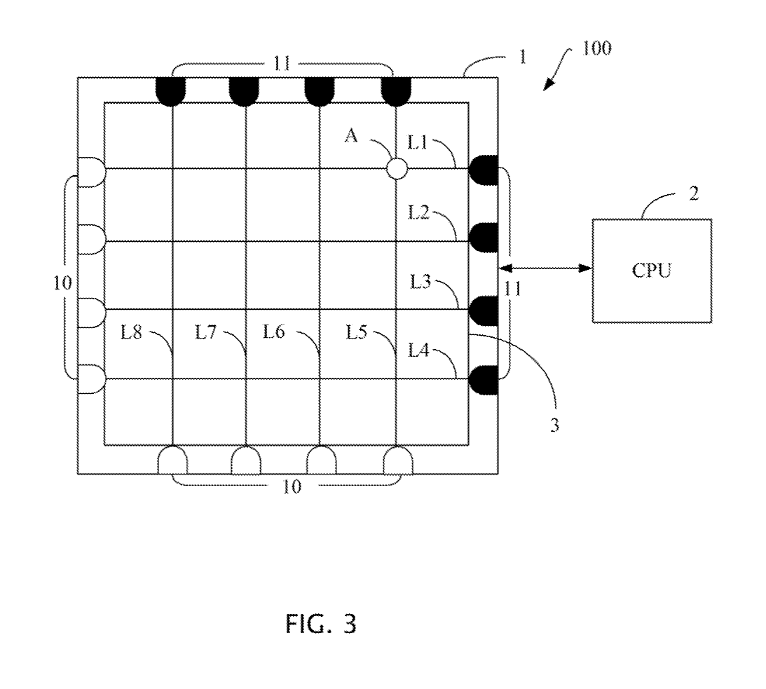

FIG. 3 shows an internal configuration of the electronic device of FIG. 2. The circuit board 12 has two pairs of oppositely disposed sides. Four light emitting devices 10 are positioned on one side of the circuit board 12 and four corresponding light detecting devices 11 are positioned on the opposite side of the circuit board 12, thereby forming four light paths L1-L4. Another four light emitting devices 10 are positioned on another side of the circuit board 12 adjacent to the prior four light emitting devices 10 and another four corresponding light detecting devices 11 are positioned on the opposite site of the circuit board 12, thereby forming four light paths L5-L7. Numbers of the light emitting devices 10 and the light detecting device 11 in FIG. 3 may be set as needed.

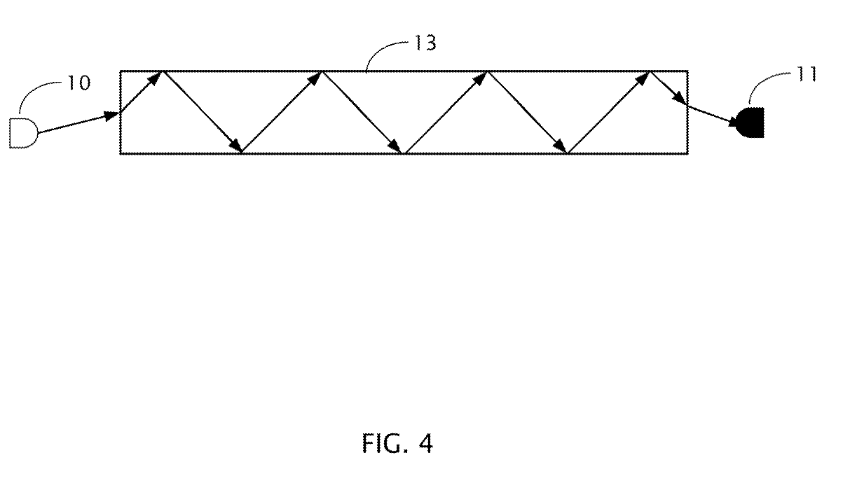

As shown in FIG. 4, without touch, the light emitting device 10 emits a beam of monochromatic light, the monochromatic light occurs total reflection in the glass 13, and then is received by the light detecting devices 11 on the other side of the sheet of glass 13.

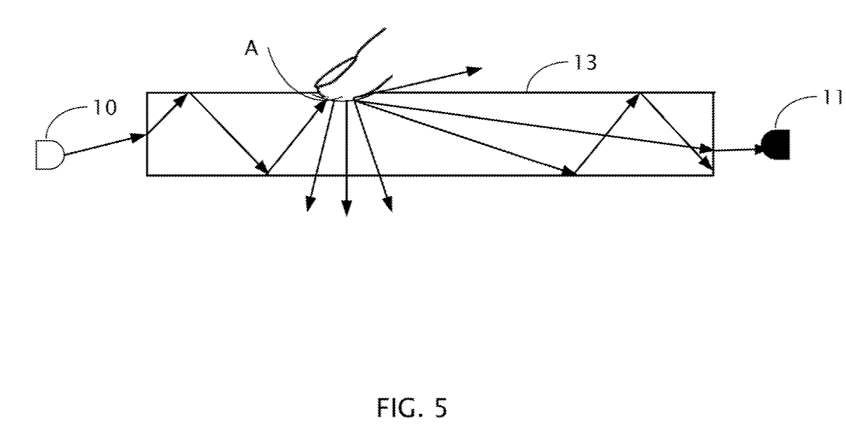

As shown in FIG. 5, when a touch operation is formed on the surface of the glass 13, the surface of the glass 13 is deformed and the monochromatic light in the sheet of glass 13 attenuates sharply even if the deformation is slight. Thereupon, the light detecting device 11 can only receive a fraction of the monochromatic light, and the electrical signals generated by the light detecting device 11 reduce sharply. The micro-processor 14 detects the change of the electrical signals, and thus determines the light path between the light emitting device 10 and the corresponding light detecting device 11 is obstructed.

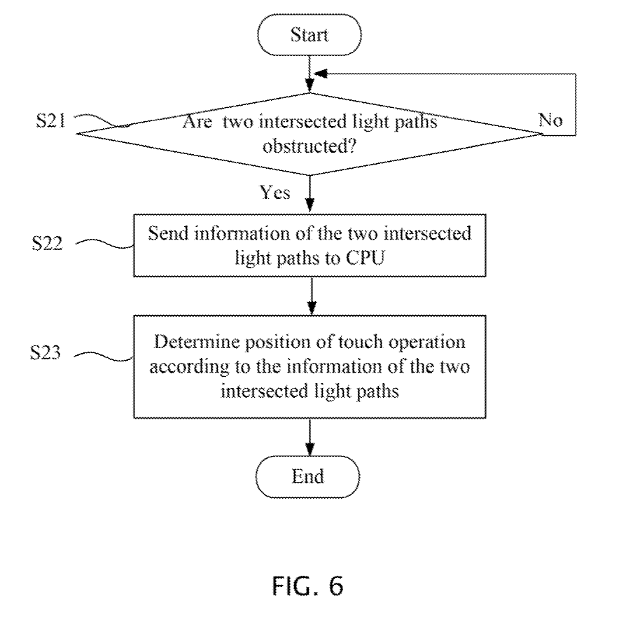

FIG. 6 is a flowchart of implementing a method of controlling the electronic device 100 of FIG. 1. In step S21, the micro-processor 14 determines if two intersected light paths are obstructed. If yes, the procedure goes to step S22, otherwise, the procedure goes to S21. In step S22, the micro-processor 14 sends the information of the two intersected obstructed light paths to the CPU 2, and the procedure goes to S23. In step S22, the CPU 2 determines the position of the touch operation according to the information of the two intersected obstructed light paths, and performs a function corresponding to the touch operation. As shown in FIG. 3, supposing point A is touched, intersected lines L1 and L5 are determined to be obstructed by the micro-processor 14, and then an intersection of L1 and L5 is determined to be the position of point A by the CPU 2.

It will be understood that the above particular embodiments and methods are shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. An electronic device with touch input function, comprising:
a display unit defining an information display area;
an touch input device comprising:
a circuit board defining an opening area which has a same size and shape as the information display area;
a sheet of glass, with surface coating, positioned on the circuit board;
at least two light emitting devices positioned around the edges of the sheet of glass on the circuit board, configured for emitting monochromatic light;
at least two light detecting devices corresponding to the at least two light emitting devices positioned around the edges of the sheet of glass on the circuit board, configured for detecting the monochromatic light emitted by the light emitting device, wherein the monochromatic light emitted from one of the light emitting devices is detected by one light detecting device, each of the light detecting devices only detects the monochromatic light emitted from one light emitting device, the monochromatic light transmitted between one of the light emitting devices and corresponding light detecting device forms a light path;
a micro-processing unit configured for controlling the at least two light emitting devices to emit monochromatic light to have a total internal reflection in the sheet of glass, detecting two intersected obstructed light paths by the at least two light detecting devices, sending information of the two intersected obstructed light paths to a central processing unit (CPU); and
the CPU configured for determining a position of a touch operation according to the information of the two intersected obstructed light paths.

2. The electronic device according to claim 1, wherein the CPU is configured for performing functions according to the touch operation.

3. The electronic device according to claim 1, wherein the circuit board has two pairs of oppositely disposed sides, the number of the at least two light emitting devices are same as that of the at least two light detecting devices.

4. The electronic device according to claim 1, further comprising a frame and a back cover, wherein the touch screen, the CPU and display unit are installed in space formed between the frame and the back cover.

5. The electronic device according to claim 1, wherein the light detecting device is photosensitive element which changes optical signals into electrical signals.

6. The electronic device according to claim 5, wherein the light detecting device is high-sensitivity photodiode.

7. The electronic device according to claim 5, wherein when no touch is formed on the surface of the sheet of glass, the at least two light emitting devices emit a beam of monochromatic light, the monochromatic light has a total reflection in the sheet of glass, and the monochromatic light is received by corresponding light detecting device on the other side of the sheet of glass.

8. The electronic device according to claim 5, wherein when a touch operation is formed on the surface of the glass, the surface of the glass is deformed and monochromatic light in the sheet of glass attenuates sharply even if the deformation is slight, the electrical signals generated by the light detecting device reduce sharply, the micro-processor determines the light path between the light emitting device and corresponding light detecting device is obstructed if detects the change of the electrical signals.

9. A method for controlling an electronic device with touch input function, comprising:
controlling at least two light emitting devices to emit monochromatic light to have a total internal reflection in a sheet of glass;
detecting two intersected light paths obstructed by at least two light detecting devices;
sending information of the two intersected obstructed light paths to a central processing unit (CPU); and
the CPU determining a position of a touch operation according to information of the two intersected obstructed light paths.

10. The method according to claim 9, wherein the method further comprises performing functions according to the touch operation.

11. The method according to claim 9, wherein the number of the at least two light emitting devices are same as that of the at least two light detecting devices.

12. The method according to claim 9, wherein the light detecting device is photosensitive element which changes optical signals into electrical signals.

13. The method according to claim 12, wherein the light detecting device is high-sensitivity photodiode.

14. The method according to claim 12, wherein when no touch is formed on the surface of the sheet of glass, the at least two light emitting devices emit a beam of monochromatic light, the monochromatic light has a total reflection in the sheet of glass, and the monochromatic light is received by corresponding light detecting device on the other side of the sheet of glass.

15. The method according to claim 12, wherein the step of detecting light paths obstructed via at least two light detecting devices comprises: when a touch operation is formed on the surface of the glass, the surface of the glass is deformed and monochromatic light in the sheet of glass attenuates sharply even if the deformation is slight, the electrical signals generated by the light detecting device reduce sharply, determining the light path between the light emitting device and the corresponding light detecting device is obstructed if detects the change of the electrical signals.
